(19) United States
(12) Patent Application Publication
(10) Pub. No.: US 2009/0246528 A1
(43) Pub. Date: Oct. 1, 2009

(54) MESOPOROUS ACTIVATED CARBONS

(76) Inventor: Rudyard Lyle Istvan, Ft. Lauderdale, FL (US)

Correspondence Address: BRINKS HOFER GILSON & LIONE, P.O. BOX 10395, CHICAGO, IL, 60610, US

(21) Appl. No.: 12/298,257

(22) PCT Filed: Feb. 14, 2007
(86) PCT No.: PCT/US07/04182

§ 371 Date: Oct. 23, 2008

(51) Int. Cl. B32B 15/02; B05D 7/00

(52) U.S. Cl. 428/403; 427/217; 977/773; 903/908; 903/907

(57) ABSTRACT

Catalytically activated carbon materials and methods for their preparation are described. The activated carbon materials are engineered to have a controlled porosity distribution that is readily optimized for specific applications using metal-containing nanoparticles as activation catalysts for the mesopores. The activated carbon materials may be used in all manner of devices that contain carbon materials, including but not limited to various electrochemical devices (e.g., capacitors, batteries, fuel cells, and the like), hydrogen storage devices, filtration devices, catalytic substrates, and the like.

### TECHNICAL FIELD

The present invention relates to activated carbons and to methods for their preparation. The activated carbons are engineered to have controlled mesoporosities and may be used in all manner of devices that contain activated carbon materials, including but not limited to various electrochemical devices (e.g., capacitors, batteries, fuel cells, and the like), hydrogen storage devices, filtration devices, catalytic substrates, and the like.

### BACKGROUND OF THE INVENTION

In many emerging technologies, electric vehicles and hybrids thereof, there exists a pressing need for capacitors with both high energy and high power densities. Much research has been devoted to this area, but for many practical applications such as hybrid electric vehicles, fuel cell powered vehicles, and electricity microgrids, current technology is marginal or unacceptable in performance and too high in cost. This remains an area of very active research, such as sponsored by the Department of Energy see DOE Progress Report for Energy Storage Research and Development fy2005 (Jan 2006 and also Utility Scale Electricity Storage by Gyuk, manager of the Energy Storage Research Program, DOE (speaker 4, slides 13-15, Advanced Capacitors World Summit 2006.

Electric double layer capacitors (EDLCs or ultracapacitors) and pseudocapacitors (PCs or supercapacitors) are two types of capacitor technology that have been studied for such applications. The primary challenges in advancing both of these technologies include improving the energy density, lowering the internal device resistance (modeled as equivalent series resistance or ESR) to improve efficiency and power density, and lowering cost. Both of these capacitive phenomena are briefly introduced below.

Electric double layer capacitor designs rely on very large electrode surface areas, which are usually made from “nanoscale rough”metal oxides or activated carbons coated on a current collector made of a good conductor such as aluminum or copper foil, to store charge by the physical separation of ions from a conducting electrolyte into a region known as the Helmholtz layer which forms immediately adjacent to the electrode surface. See U.S. Pat. No. 3,288,641. There is no distinct physical dielectric in an EDLC. Nonetheless, capacitance is still based on physical charge separation across an electric field. The electrodes on each side of the cell and separated by a porous membrane store identical but opposite ionic charges at surface double layer interface with the electrolyte solution in effect becomes the opposite plate of a conventional capacitor for both electrodes. However, large commercial EDLCs are presently too expensive and insufficiently energy dense for many applications such as hybrid vehicles and are used instead in small sizes primarily in consumer electronics for fail-soft memory backup.

It is generally accepted that EDLC pore size should be at least about 1-2 nm for an aqueous electrolyte or at least about 2-3 nm for an organic electrolyte to accommodate the solvation spheres of the respective electrolyte ions in order for the pores to contribute their surface for Helmholtz double layer capacitance. See J. Electrochem. Soc. 148(8) A910-A914 (2001) and Electrochem. & Solid State Letters 8(7) A357-A360 (2005). Pores also should be accessible from the outer electrode surface for electrolyte exposure and wetting, rather than closed and internal. The more total accessible pores there are just above this threshold size the better, as this maximally increases total surface area. Substantially larger pores are undesirable because they comparatively decrease total available surface. It has been shown that pores much above 13 nm, although contributing capacitance, may reduce total surface. See Carbon 39 937-950 (2001) and Eurocarbon Abstracts (1998) 841-842. Conventional activated carbons used in such ELDC devices have many electrochemically useless micropores (i.e., below 2 nm according to the IUPAC definition). The pore size must be approximately the sphere of solvation of electrolyte ions, or larger, to accommodate solvated electrolyte ions necessary for the Helmholtz layer to form. See U.S. Pat. No. 6,491,789. For organic electrolytes, these pores should ideally be larger than 3-4 nm since solvated electrolyte ions have dimensions on the order of 1.7 nm to 2 nm, and “both sides” of a pore have potentially usable surface. See, for example, Carbon 40 (2002) 2613. In the best highly activated electrochemical carbons reported in the literature, actual measured EDLC is less than 20% of theoretical (based on BET measured total surface) due to suboptimal pore size distributions, with a large fraction (typically more than a third to half) being micropores. See U.S. Pat. No. 6,737,445. A separate problem with highly activated carbons in electrochemical devices is their increased brittleness and lower electrical conductivity, with experimentally determined conductivity as low as 7 S/cm.

Pseudocapacitors can be built based on electrochemical pseudocapacitance in one of three forms: electrosorption of electrolyte ions onto the surface of an electrode, an oxidation/reduction (redox) reaction at the electrode surface, or ionic doping/depletion of a conducting polymer. These are all Faradic processes involving charge exchange, as compared to the purely non-Faradic electrostatic charge separation process in EDLC. Pseudocapacitors tend to have higher RC constants than EDLCs because of the reversible electrochemical nature of the charge storage mechanisms, and so are more battery like than capacitor like. Present devices have RC constants ranging from seconds to hundreds of seconds. Redox pseudocapacitance devices (called supercapacitors) have been developed commercially for military use but are very expensive due to the cost of constituent rare earth oxides (RuO₂) and other metals.

Commercial EDLCs today are too expensive and insufficiently energy dense for applications such as hybrid vehicles. PCs are far too expensive for such uses. Although both charge storage mechanisms may co-exist in both types of capacitors, in present commercial devices one or the other predominates. If the two mechanisms could be cost effectively combined on a large scale in one device, the device would have the characteristics of both a power capacitor and a battery, and might find substantial markets in applications such as hybrid electric vehicles.

Several alternative approaches to producing a high surface carbon material suitable for EDLC operation with organic electrolytes at their desirable higher operating voltages have been undertaken. These include physical activation using carbon dioxide, steam, or air, chemical activation using for example KOH, NaOH, or H₃PO₄, carbon aerogels, various templating techniques, and carbon nanotubes or equivalents.

Both physical and chemical activation have been shown to create two kinds of surfaces. Traditionally, it has been thought that most surface enhancement comes from enlarging preexisting micropores caused by the disordered graphene crystallite (or equivalent) carbon microstructure. The actual microstructures of many carbons contain surprisingly little graphene because of the presence of SP₂ bonds in 5 and 7 ring configurations as well as the conventional 6 ring (graphite, benzene), which therefore induces curvature. For a current overview, see Harris, Critical Reviews in Solid State and Mat. Sci. 30:235-253 (2005). Therefore they contain little in the way of microslit pores even when the precursor carbon is a highly ordered polymer such as a phenolic novoloid resin like KYNOL™ (available from American Kynol, Inc., Pleasantville, N.Y.). See Proceedings of the 8^{th} Polymers for Advanced Technology International Symposium in Budapest 11-14 Sep. 2005. The highly tortuous internal pore structure is widened by activation eroding the carbon subunits, and beyond some dimension will allow solvated ions to enter and use at least a portion of the internal pore surface for double layer capacitance. See J. Phys. Chem. B 105(29) 6880-6887 (2001). These pores are randomly distributed, at least in all turbostratic non-graphitizing carbons. Randomness is easily shown by x-ray crystallography. See Harris, Critical Reviews in Solid State and Mat. Sci. 30:235-253 (2005).

The second kind of surface is additional exterior surface as nanoparticles of carbon are spalled or etched away by convergence of activated micropores. These features tend to be less than 10 nm (individual carbon subunit pitting) to less than 100 nm in diameter (subunit agglomerate spalling), and the detritus tends to form aggregates that “decorate” the exterior surface of the larger carbon particles (typically a few microns in diameter). See DOE Project DE-FG-26_{—}03NT41796, June 2005. Similar carbon ‘decoration’ nanoparticles have been observed with chemical activation. See J. Electrochem. Soc. 151(6) E199-E205 (2004). The result is a substantial amount of exterior surface simply caused by roughness from spalling and pitting, quantifiable according to the IUPAC definition of rugosity. This rugosity can be quite substantial, may account for over a hundred square meters of surface per gram, and comprises a significant contribution to total double layer capacitance (typically ranging from nearly all to as little as one third). See J. Power Sources 154 (2006) 314-320. Exterior carbon surfaces have been micrographed using STM and TEM and represent many fold increases over unactivated carbon precursor. See Proceedings of the 8^{th} Polymers for Advanced Technology International Symposium in Budapest 11-14 Sep. 2005. It has been known for years that “chemically roughened” metal electrodes with no interior micro/mesopores increase rugosity from by 30 (gold) to 100 ( aluminum low voltage electrolytic capacitor ‘gain’) fold. See J. Electroanal. Chem. 367: 59-70 (1994) and Electrolytic Capacitors (written by Brian Conway, University of Ottawa, 2003), in the Electrochemistry Encyclopedia maintained by the Electrochemical Science and Technology Information Resource (ESTIR), Yeager Center for Electrochemical Science (YCES), Case Western Reserve University.

www.electrochem.cwru.edu.

Such a rugose carbon exterior surface becomes self replicating and therefore self limiting with conventional physical or chemical activation. The spalling of nanoparticulate carbon subunit aggregates and the pitting of the remaining surface at the level of individual carbon subunits, both demonstrated by direct imaging references in the preceding paragraph, reach a maximum rugosity beyond which additional spalling or pitting results in a new surface that is substantially equivalent to the old. As a simple analogy, removing a stone from a pebble beach or a grain of sand from a piece of sandpaper does not materially change the overall beach or sandpaper surface; it is as rugose as before. Such a surface may even become less rugose with higher activation if the agglomerates and individual subunits themselves are affected by activation. Experimental proof of self replicating external rugosity was obtained (during the course of research into the herein disclosed methods of activating mesoporous carbons) by activating commercial carbonized KYNOL for periods ranging from 15 minutes to 1 hour in 30% steam/nitrogen at 900° C., and examining the resulting exterior surface using standard BET isotherms, DFT isotherms, and SEM images. Precarbonized KYNOL is known to be difficult to subsequently activate due to very limited microporosity. Therefore, even with 1 hour activation, the region of KYNOL carbon affected by activation did not extend more than 500 nanometers into the 13 micron diameter material. The surface obtained at 15 minutes was 110.6 square meters with from 4.6 to 7.2% mass loss; the surface obtained at 1 hour was 112.2 square meters with from 8-10% mass loss. That is a nearly identical surface after about double the mass loss and a quadrupling of activation time. The two surfaces are visually similar at 20,000× magnification and show spalls averaging less than 100 nm diameter and at least 100 nm deep. Magnification with the SEM machine used for the experiment was insufficient to resolve surface pitting within the spalls on the order of 5-10 nm as imaged by others using TEM and STM; however, DFT estimates of meso and macroporosity suggest they exist.

It has been shown that in at least some carbons, the exterior surfaces can contribute several times the capacitance per square meter of surface of interior pore surface. See Electrochimica Acta 41(10)1633-1630 (1996). This makes sense for two fundamental reasons. First is the probability of access to internal mesopores. Pores exist in some random size distribution, although the peak of the distribution will shift to larger pores and the distribution's shape may change with activation. See for example Electrochimica Acta 41(10) 1633-1630 (1996) and J. Electrochem. Soc. 149(11) A1473-1480 (2002) and J. Electrochem. Soc. 151(6) E199-E205 (2004). Normally there is a substantial majority of the distribution that remains micropores under 2 nm, and even with high activation some proportion comprising pores under 1 nm. Since the size of the solvated ions in organic electrolytes range from about 11.9 to 16.3 to about 19.6 Angstoms in diameter depending on salt and solvent (see J. Electrochem. Soc. 148(8) A910-914 (2001) and Carbon 40 2623-2626 (2002)) these ions will be blocked or sieved out (molecular sieving) by intervening micropores and prevented from accessing interior mesopore surface for capacitance. Ionic sieving where one of the two solvated electrolyte ions is not highly sieved and the other nearly completely is have been well demonstrated both in aqueous (see J. Phys. Chem. B 2001, 105(29): 6880-6887 and in organic electrolytes (see Carbon 2005, 43:1303-1310). The larger (sieved) ion becomes kinetically controlling for double layer capacitance. Any pore below the critical size will block (screen or sieve) all the pore surface interior to that point accessible through that point; therefore the probability of access declines with depth in a way stochastically dependent on the pore distribution. The probability of accessing internal mesopores via the intervening general pore structure is therefore a direct function of the pore size distribution (strict combinatorial probability theory) and the degree to which the pores may also multiply interconnect (percolation theory). For most activated carbon pore size distributions, an appreciable fraction is sieving pores that prevent passage of solvated electrolyte ions; therefore the majority of internal pore surface is probabilistically inaccessible. As experimental proof, exceptional materials without sieving pores also demonstrate exceptional double layer capacitance at or very close to the theoretical maximums for their carbon surface and electrolyte system. See Applied Physics Letters 2003, 83(6): 1216-1218 for activated espun PAN in potassium hydroxide electrolyte, Adv. Funct. Mater. 2001, 11(5):387-392 for single walled carbon nanotubes with potassium hydroxide, J. Electrochem. Soc. 2002, 149(11):A1473-1480 for carbonized PVDC copolymers in sulfuric acid, and Carbon 2003, 41:2680-2682 and ABST 642, 206^{th} meeting of the Electrochemical Society for exfoliated carbon fibers with sulfuric acid.

Direct experimental evidence for the substantial and relatively invariant contribution of a rugose exterior surface, with an additional contribution of accessible internal mesoporosity varying from nothing to more than the exterior (depending on carbon activation, average pore size, and electrolyte) has been obtained using nuclear magnetic resonance on ¹⁹F. The relative contributions of exterior surface and internal porosity can be distinguished. EDLC carbons were evaluated using tri-ethylmethyl ammonium fluoroborate (TEMA/BF₄) salt in propylene carbonate solvent as the electrolyte system. The internal porosity ion population [and hence capacitive contribution] of the anion BF₄ ranged from zero at a carbon average pore size of 0.89 nm, to about half the total at an average pore size of 1.27 nm, to about two thirds of the total at an average pore size of 1.64 nm. See Ikeda (Asahi Glass Co. Ltd. Research Center) 16^{th} International Seminar on DLC, 5 Dec. 2006, and Yamada et. al. in Denki Dagaku, spring 2002.

The combined contribution of the true exterior surface of a carbon particle, which can be increased by rugosity, and the accessible proportion of internal porosity, which can be increased by activation, has been termed proximate exterior by the inventor. Only those internal pores reasonably proximate to the true exterior, and therefore having a reasonable probability of being accessible to electrolyte rather than being inaccessible due to sieving, can contribute their surface to some degree for capacitance. This novel yet simple insight can be mathematically modeled as shown below, and can be used to approximate the actual EDLC performance of all manner of activated carbons.

There is a second and more subtle reason interior mesopores can be problematic. Even if solvated electrolyte ions can gain access through a sufficiently large sequence of apertures (openings between pores), the rigid organization of the adsorbed Helmholtz layer once an electric field is applied to charge the capacitor means that no further electrolyte is capable of diffusing into the interior unless all apertures are greater than about 2.5 times to 3 times the dimension of the Helmholz layer (that is, at least one adsorbed solvated ion on each side of the pore, plus space for one further solvated ion to pass between for further mass transport. The actual minimum aperture as a function of solvated ion diameter depends on the geometry of the pore, being 3.0 for circular apertures and 2.43 for square apertures as a simple consequence of sphere equivalent topological packings. See Weisstein, CRC Concise Encyclopedia of Mathematics, 2^{nd} Ed. and Weisstein, MathWorld, Wolfram Research, Inc. Since the constituent solvated ions are on the order of 1 to 2 nm, apertures less than about 3 to 6 nm depending on electrolyte will “pack shut”. Take the simplest case of carbon nanofoams, or their equivalent spherical silicatemplates. Micrographs from ORNL and LLNL and commercial suppliers regularly show that the spherical pore “bubbles” have orifices or apertures between them that are about one fifth the diameter of the pores themselves, created where the “bubbles” touch. See U.S. Pat. No. 6,673,328 and Langmuir 2002, 18(6): 2141-2151. Such a pore less than 30 nm in diameter may have its apertures pack shut under charge with aprotic electrolytes. Such a pore under 20 nm is almost certain to. Only the electrolyte ions already to the interior of that point can then contribute capacitance, as more have difficulty entering once a charging voltage is applied. Spherical pores are the best case, since they maximize volume and minimize surface, and therefore will contain the most solvated ions and have the most subsequent capacitance. Reasonably precise mathematical models of this process have been constructed using analytic geometry, the ideal packing density for spheres at the Kepler limit of 0.74 (assuming true solvation spheres for ions in electrolyte), the caging, contact, and kissing numbers for randomly packed spherical pores, and estimates based on micrographs about the resulting number and relative size of apertures. A 20 nm spherical pore will only contain 107% of the required solvated ions for maximum surface coverage (computed using standard Et₄N BF₄ salt in acetonitrile (AN) solvent at 1 molar concentration); a 15 nm sphere has only 80%. A 10 nm sphere has only 53% of the required ions; an 8 nm sphere only 43%. This results in local depletion under charge due to aperture blockage, and loss of effective surface. It explains the disappointingly low specific capacitance despite the very high cost of most templated carbons. For templated carbons with roughly spherical pore structures, the mathematical models reproduce the surprising experimental results nearly exactly in both aprotic and aqueous electrolytes. See, for example, Fuertes, Electrochimica Acta 2005, 50(14):2799-2805.

Since activated carbons (either physical or chemical activation) have both sieving and depletion issues with interior pore surface, their exterior particle surfaces are disproportionately important. Although carbon materials such as aerogels or templates may substantially resolve probability of access by providing larger and more uniform pore size distributions, much surface has aperture restrictions that result in local depletion under charge and an inability to fully utilize the interior surface.

Kyotani, Carbon (2000) 38: 269-286, have summarized available methods for obtaining mesoporous carbon. Lee et al., Chem. Commun. (1999) 2177-2178, described a mesoporous carbon film for use with electrochemical double-layer capacitors. Most commercial electrocarbons from suppliers such as Kuraray in Japan (BP20), Kansai Coke in Korea (MSP20), or MeadWestvaco (Glen Allen, Va.), use conventional physical or chemical activation. One example of chemical activation intended for EDLC electrocarbons is potassium hydroxide. See U.S. Pat. No. 5,877,935, and Carbon 2002, 40(14) 2616-2626 for KOH activation of a commercial mesopitch and J. Electrochem. Soc. 2004, 151 (6):E199-E2105 for KOH activation of PVDC. However, these carbons produce capacitances ranging from 30-35 F/g (two electrode cell basis) or 120-140 F/g of specific capacitance (three electrode reference system basis). That is not appreciably different than the best conventional physically activated carbons that may have capacitance of 100 to 140 F/g (3 electrode reference basis) with BET surface areas ranging from about 1500 to 2000 square meters. Reports of Res. Lab. Asahi Glass Co LTD, 2004, 54: 35 in reporting on their experimental ultracapacitor development for Honda Motors. Honda itself in conjunction with Kuraray has announced commercial introduction of a KOH activated mesopitch with activation based on U.S. Pat. No. 5,877,935 using a precursor mesopitch based on U.S. Pat. No. 6,660,583. This material is reported to have up to 40 F/g in two electrode cells, equivalent to nearly 160 F/g specific capacitance in a three electrode reference system. It is, however, more expensive than simple physical activation, and a portion of the observed charge arises from intercalation pseudocapacitance (as in lithium ion batteries), potentially introducing cycle life limitations. See Fujino's paper on the Honda material (speaker 10, slide 12) at the Jul. 17-19, 2006 Advanced Capacitors World Summit.

A second approach has been various forms of carbon aerogel. See U.S. Pat. No. 5,626,977. However, the supercritical drying step-whether by carbon dioxide, isopropyl alcohol, or cryogenic extraction (freeze drying) makes these carbons relatively expensive but with at best only modest performance improvements. (See J. Appl. Polym. Sci. 2004, 91:3060-3067, and Smith (U.S. Naval Surface Warfare Center) Proceedings of the 16^{th} International Seminar on DLC 4-6 Dec. 2006 pp 277-284). Carbon aerogels are usually limited in surface area to between about 400 and 700 square meters, although much of this surface is accessible to electrolyte. Depending on pore distribution, a substantial proportion (over half) can be subject to local depletion. Even with activation and aqueous electrolytes, the best carbon aerogels are not substantially different from conventional physically activated carbons. See J. Power Sources, 2002, 105:189-194.

A third approach is to use some sort of a template or structure to form pores of suitable dimension and connection geometry. One method uses aluminosilicate nanoparticles of various types, for example as described in U.S. Patent Publication 2004/0091415. These are presently even more expensive than aerogels because of the need to prepare the template and then at the end to remove it, usually by dissolving in hydrofluoric acid. Many of these carbons have demonstrated disappointing capacitance in aqueous sulfuric acid, let alone organic electrolytes with larger solvated ions. See Hyeon's summary overview of Korean experimental work in J. Mater. Chem. 2004, 14:476-486. One of the best experimental carbons according to this method used aluminosilicate templates averaging 8 nm; the carbon achieved a disappointing 90 F/g specific capacitance with TEA/AN electrolyte despite a 1510 m² BET surface, fully explainable by aperture restrictions and local depletion. See Electrochimica Acta 2005, 50(14):2799-2805.

Another approach uses carbide particles from which the metal is then leached by hot chlorine or fluorine, for example as described in Electrochem. and Solid State Letters 2005, 8(7):A357-A360) and Arulepp et. al. J. Power Sources (2006) in press. Carbons made by one version of this carbide approach (described in PCT/EE2005/000007) ranged from 115 to 122 F/g specific capacitance. See Proceedings of the 15^{th} International Seminar on Double Layer Capacitors Dec. 5-7, 2005, pp. 249-260. Another group using a similar approach has achieved 135 F/g, but with some intercalation pseudocapacitance. See Electrochemical and Solid State Letters 2005, 8(7):A357-A360 and J. Power Sources 2006, 158(1) 765-772. The purported anomaly supposedly enabling double layer capacitance in pores less than 1 nm (see Chmiola et. al. in Science Express, 17 Aug. 2006 page 1 (10.1126/science.1132195, the immediate online publication service of the journal Science www.scienceexpress.org) is simply and fully explained by particle rugosity; the internal micropores of the material contribute virtually no capacitance. Rather, the precursor particles are unusually small, being 1-3 micron in diameter, and therefore have disproportionately more external surface for a given volume of material and therefore an unusual proximate exterior. See example 4 below.

Yet another approach uses surfactant nanomicelles. TDA carbons made according to U.S. Pat. No. 6,737,445 were reported at the 2002 National Science Foundation Proceedings to have only 81 F/g to 108 F/g (owing to local depletion), and have proved difficult to scale to commercial quantities despite substantial federal funding support. A related approach uses nanomicelle dehydration of precursor carbohydrate solutions followed by thermal processing. The resulting electrocarbon has over 1500 BET surface but only about 94 F/g to 97 F/g specific capacitance. Its advantage is using an inexpensive, chemically pure precursor (sugar). See U.S. publication 2005/0207962, and MeadWestvaco's resulting specific capacitance (speaker 20, slide 14) reported at the Advanced Capacitors World Summit 2006.

Yet another approach uses liquid crystal materials in a carbon electrodeposition according to U.S. Pat. No. 6,503,382. These carbons, however, have the disadvantages of being thin films with rather large pores, so only limited surface areas and capacitance.

Yet another approach is to use some form of carbon nanotube (also known as fibril), either single wall or multiwall, and either grown separately and applied as an entangled fibrous material, or grown in situ in a vertically aligned fashion. An example of an electrode made from separate fibrils is U.S. Pat. No. 6,491,789. Another is U.S. Pat. No. 6,934,144. Vertically aligned carbon nanotubes ultracapacitors are being investigated among others by MIT with sponsorship from Ford Motor Company. Entangled CNT have two serious drawbacks. First, the material is very expensive, several dollars per gram compared to electrocarbons at $40 to $100 dollars per kilogram. Second, the material has a Young's modulus of elasticity nearly equivalent to that of diamond at around 1200 (extremely stiff), and is therefore extremely difficult to densify to take full advantage of the surface presented by the very fine fibers. Not surprisingly, Frackowiak et. al. reported that ELDC devices made using mesopores from multi-walled carbon nanotube “entanglement” had capacitance ranging widely from 4 to 135 F/g in aqueous electrolytes, highly dependent on multi-walled carbon nanotube density and post processing (further densification). See Applied Physics Letters, Oct. 9 2000, 77(15): 2421-2423. The best reported capacitances are not better than activated carbons. See J. Mater. Chem. 2005, 15(5) 548-550. Vertically aligned CNT grown in situ using CVD in a vacuum overcomes the Youngs' modulus packing problem, but has only achieved BET surfaces of about 500 square meters per gram due to the large spacing between of individual nanotubes, and is extremely expensive as well as low volume with present semiconductor like manufacturing technology. See MIT report paper number 2, 16^{th} International Seminar on DLC, pp 15-22. Others have explored using carbonized electrospun fibers as carbon nanotubes equivalents in order to reduce cost, for example U.S. Patent Application 2005/0025974; but espinning is not yet capable of producing commercial quantities of carbonizable fiber. Others have explored in situ vapor deposition of porous carbonaceous materials without fibril structure, for example U.S. Pat. No. 6,697,249.

Others have tried using catalytic agents to enhance mesoporosity during conventional physical activation. Oya et al., Carbon (1995) 33(8):1085-1090, mixed cobalt-acetylacetonate with phenolic resin and methanol solvent, then spun, cured, carbonized and activated large diameter fibers to obtain carbon fibers of moderate surface area compared to conventional activation, but with some large (several 10s of nm) mesopores generated by the cobalt together with a preponderance of micropores. In these experiments, the best resulting total surface of materials with cobalt admixed was less than 1000 square meterslg compared to as high as 1900 square meters/g without. Total mesopore surface as a proportion of total surface did not exceed 27% (only 170 square meters/g) in the best case even at 40% burnoff. Oya found the activated fibers problematic because they became very fragile due to catalytic graphitization of the interior carbon material. Oya did not consider, nor report on, cobalt particle sizes resulting from his process since almost none were observed; this is because of the molecular nature of the mixing of the organometallic in solution with dissolved phenolic precursor resin.

Hong et al., Korean J. Chem. Eng. (2000) 17(2): 237-240, described a second activation of previously activated carbon fibers by further catalytic gasification. Hong started with conventional commercially available activated carbon fibers having only 11.9% mesopores and a surface area of 1711 square meters/g (mostly micropores under 2 nm). He used cobalt chloride precursor coated in solution to catalytically produce a material with 56% mesopore volume compared to about 23% for a comparable second activation without cobalt. However, the additional mesopore size distribution peaked at about 2 nm and there was no appreciable difference in the proportion of mesopores above 4 nm. Therefore the total surface area only increased to 1984 square meters/g compared to 1780 square meters/g after second activation without the cobalt (200 incremental square meters of 2 nm mesopores). Hong specifically found that brittleness did not increase, unlike the Oya result. Hong did not consider nor report the size of any cobalt particles formed by his process, but if any were able to form must have been under 2 nm given the resulting mesopore distribution in his data.

Tamai and co-workers developed methods for using rare earth oxide precursors dissolved together with precursor pitches to create mesoporous activated filtration carbons. Chem. Mater. 1996, (8) 454-462. His group later used the method to examine EDLC electrocarbons. Tamai dissolved together up to 3% yttrium acetylacetonate with polyvinyldiene chloride (PVDC, or Saran)/acrylonitrile or methyl acrylate co-polymers in tetrahydrofuran (THF) solvent, and found that mesopore distributions peaking from 4 nm to 7.5 nm could be created by a high degree (70% burnoff) of physical (steam) activation of the resulting carbonized compounds. See Carbon 41(8) 1678-1681 (2003). PVDC co-polymers have been well studied in Japan as a preferable EDLC carbon precursor because of unusually high carbonized porosity prior to activation, well characterized pore size distributions, and high capacitance in sulfuric acid electrolytes without activation. See, for example, J. Electrochem. Soc. 149(11) A1479-A1480 (2002) and J. Electrochem. Soc. (2004) 151(6):E199-E205. Tamai's best resulting yttrium catalyzed carbons surprisingly only had capacitances of 34 and 35 F/g (two electrode cell), equivalent to 136 and 140 F/g specific capacitance in a three electrode reference system. The explanations for this surprisingly disappointing EDLC result given conventional wisdom concerning the unusually high mesopore distribution were given above. Since the Tamai process formed pores within the material, the resulting internal mesopores have the internal access probability issues of any activated carbon, so were only marginally accessible given the remaining proportion of sieving micropores. Much of the interior mesoporosity is probabilistically unavailable and most of the remainder is subject to local depletion. Most EDLC arises from the proximate exterior, which does not change substantially for the doped and undoped materials.

By way of further example of the inaccessibility of internally created catalytic mesopores, Oya and co-workers followed the general methods of Tamai using nickel acetylacetonate in THF solvent blended into precursor phenolic resins at a concentration of 0.1% by weight. Upon carbonization and steam activation, they generated a range of activated carbon fibers with very large mesopores (some materials having average pore radius (rather than diameter) in excess of 10 nm). Yet the resulting materials were only marginally better than carbon fibers comparably made and activated without the nickel. Capacitances ranged from about 80 to about 100 F/g with total surfaces from around 1000 square meters to as high as about 1700 square meters, in lithium perchlorate/propylene carbonate electrolyte. See J. Electrochem Soc. 2002, 149(7):A855-A861.

Edie and Besova finely ground metal acetylacetonates or other metal salts, mixed them with precursor mesopitch, melt spun a fiber containing the particles, then carbonized and activated the fiber. They found that the organometallic material formed nanoparticles ranging from about 10 nm to about 100 nm, and that during activation these particles etched large channels resembling worm holes throughout the material, some of which terminated on the surface. Such particles and channels were so large as to be readily visible in SEM micrographs. These channels substantially facilitated hydrogen storage. However, these particles are much larger than optimal for electrocarbons, were relatively few in number, required a very high degree of activation (55% burnoff), yet only increased the carbon surface by 100 square meters per gram. Various organometallics and metal salts, and combinations thereof produced a variety of pore distributions and total surface areas. All of the reported materials, however, contain a proportion of sieving micropores blocking access to interior mesopores. Carbon 2005, 43(7):1533-1545. Therefore the method does not sufficiently enhance usable mesosurface for electrochemical applications such as EDLC.

Trimmel et. al. New Journal of Chemistry 2002, 26(2):759-765 made nickel oxide nanoparticles in and on silica with various average diameters from as small as 3 nm up to several nm from various organometallic precursors by varying the precursor conditions. Park and coworkers demonstrated a process for making free standing nickel nanoparticles ranging from 2 nm to 7 nm from precursor organometallics, again by varying process conditions. See Adv. Mater. 2005, 17(4):429-434. The Japanese organization NIRE reported in 1997 and 1998 in their annual reports that their coal researchers had been able to form various metal oxide nanoparticles with diameters ranging from 5 to 10 nm using organometallic metal acetylacetonates dissolved in THF simply by coating particulate brown coal followed by flash evaporation of the solvent, These nanoparticles subsequently catalyzed mesopores in steam activated coal, producing a potential mesoporous filtration carbon. See Energy and Fuels 11 327-330 (1997). Lacking the theory of proximate exterior, and following conventional wisdom about maximizing internal mesopores ideally not much larger than 2-3 nm, these investigators did not consider potential implications for electrocarbons. It is apparent from the foregoing discussion as well as from the many current research efforts to find improved electrocarbons that enhanced carbon materials overcoming these intrinsic physical limitations are a large unmet need.

### BRIEF SUMMARY OF THE INVENTION

The scope of the present invention is defined solely by the appended claims, and is not affected to any degree by the statements within this summary.

One embodiment of the present invention is a method of preparing a mesoporous carbon with enhanced proximate exterior comprising providing carbon particles of at least micron dimensions, coating the particles with organometallic precursor or otherwise derived metal and/or metal oxide nanoparticles, and activating the carbon particles such that the nanoparticles preferentially etch mesopores into the surface of the particles. These mesopores are formed from the exterior to the interior of the particles, enhance exterior surface rugosity many fold, if beyond the minimum thresholds are not locally depleted under charge because they have no apertures, and improve the probability of access to adjacent regularly activated pores. They increase proximate exterior.

Another embodiment of the present invention is to coat the organometallic precursor or otherwise derived nanoparticles onto a carbon precursor, such as a melt spun pitch fiber, a polymer fiber, or a polymerized particle such as raw as-made PVDC, then carbonizing the carbon precursor prior to activation to result in a material with increased proximate exterior.

Another embodiment of the present invention is to further mill the mesoporous carbon particles of the present invention to a final desired geometry and size distribution, preferably before coating and activation. As used herein, “mesoporous carbon material of the present invention” refers to either mesoporous carbon particles formed by the method of the present invention or milled mesoporous carbon particles therefrom.

Another embodiment of the present invention is to further form a layer comprising a binder and the mesoporous carbon materials of the present invention.

Another embodiment of the present invention is a carbon powder comprising a plurality of the mesoporous carbon materials of the present invention.

Another embodiment of the present invention is a material comprising a binder and the mesoporous carbon materials of the present invention.

Another embodiment of the present invention is an electrode comprising a current collector and the mesoporous carbon materials of the present invention in electrical contact with the current collector.

Another embodiment of the present invention is a capacitor comprising the mesoporous carbon materials of the present invention.

### DETAILED DESCRIPTION OF THE INVENTION

Precisely engineered mesoporous activated carbon materials have been discovered and are described herein. The materials have very high proximate exterior mesosurfaces especially well-suited for use in double layer capacitors or fuel cells, batteries, and other electrochemical applications, and may be prepared by methods involving catalytic activation using nanoparticles averaging over 2 nm diameter. The preparation methods described herein provide control over the rugosity, pore geometry, and proximate exterior of the carbon materials, resolving both the probability of access and the local depletion limitations of other carbon materials. Activated carbons with enhanced rugosity, conventional activation pores, and structure according to this invention have comparably higher proximate exterior characteristics tailor-made for specific applications including, but not limited to, electric double layer capacitors, certain battery electrodes, and fuel cell electrodes. Moreover, through the addition of certain metal oxide catalyst nanoparticles, these materials have the further advantage in capacitors of optionally contributing pseudocapacitance with certain electrolytes from selected metal oxides, in addition to the Helmholtz layer capacitance from the activated carbon surface, thereby enhancing the energy density of a hybrid capacitor cell.

Throughout this description and in the appended claims, the following definitions are to be understood:

The term “mesoporous” as used in reference to a carbon describes a distribution of pore sizes wherein at least about 30% of the total pore volume has a size from about 2 to about 50 nm in accordance with the standard IUPAC definition. A typical mesopore proportion for conventional activated electrocarbons may range from a low of 5% to a high of 22% mesopore. See Walmet (MeadWestvaco), 16^{th} International Seminar on DLC.

The phrase “catalytically activated” as used in reference to a carbon refers to its porous surface wherein mesopores have been introduced from the external surface of the carbon particle or fiber toward the interior by a catalytically controlled differential activation (e.g., etching) process. In some embodiments, metal oxide particles of a chosen average size serve as suitable catalysts and a least a portion of the metal oxides remain in or on the carbon after the activation process.

The term particle used in reference to polymers and carbons refers to a distribution of precursor materials conventionally from about 1 micron to about 100 microns in diameter, such as are conventionally prepared prior to physical or chemical activation, as described for example in U.S. Pat. No. 5,877,935.

The phrase “fiber” used in reference to polymers and carbon refers to filamentous material of fine diameter, such as diameters less than about 20 microns, and preferably less than about 10 microns, such as the type that may be obtained using conventional solvent or melt spinning processes or unconventional spinning processes such as electrospinning.

The phrase nanoparticle used in reference to catalytic particles means a nanoscale material with an average particle diameter greater than 2 nm and less than 50 nm.

In presently preferred embodiments, the precursor carbon may come from any source of sufficient purity to be used as an electrocarbon (either with or without an additional final chemical purification step such as acid washing), including naturally occurring materials such as coals, plant matter (wood, coconut shell, food processing remainders (pulp, pith, bagasse), or sugars), various petroleum or coal tar pitches, specialized pitch precursors such as described by U.S. Pat. No. 6,660,583, or from synthetic polymeric materials such as polyacrylonitrile (PAN) or polyvinyldiene chloride (PVDC). Although a specialized carbon precursor material is conventionally desirable for purity, the present invention is not limited thereto but comprises any chemically suitable precursor capable of being carbonized, and activated.

An organometallic nanoparticle can be either a metal or metal oxide nanoparticle separately created or a chemical precursor thereto. These nanoparticles are introduced during one or more of the processing stages to provide catalytic sites on the carbon particle surface for the subsequent etching of pores from the exterior toward the interior of the carbon during the activating stage(s) and/or to provide a desired electrochemical activity. The metal or metals of the metal-containing materials are selected based on their catalytic and/or electrochemical activities.

In some embodiments, the organometallic nanoparticle comprises a metal oxide nanoparticle, a combination of different metal oxide nanoparticles, or alloys thereof. In some embodiments, the metal oxide nanoparticles have diameters of up to and including about 50 nm, in other embodiments, up to and including about 15 nm, in other embodiments, up to and including about 8 nm, in other embodiments, up to and including about 4 nm, in other embodiments, up to and including about 3 nm, and in other embodiments, about 2 nm. The preferred particle size mode will depend on the choice of electrolyte, but preferably be a minimum of at least 3× the diameter of the kinetically controlling solvated electrolyte ion.

In some embodiments, the metal oxide nanoparticles comprise oxides of iron, nickel, cobalt, titanium, ruthenium, osmium, rhodium, iridium, yttrium, palladium, platinum or combinations thereof. In some embodiments, the metal oxide nanoparticles comprise nickel oxide. In some embodiments, the metal oxide nanoparticles comprise iron oxide. In some embodiments, the nanoparticles comprise alloys of two or more metals such as nickel and iron. In some embodiments, the metal/metal oxide nanoparticles are suspended in nonpolar organic solvents like toluene or hexane.

In some embodiments, the organometallic nanoparticle comprises an organometallic metal oxide precursor or a mixture of such precursors. In some embodiments, the metal oxide precursor comprises a metal acetylacetonate with THF, toluene, benzene, benzyl alcohol, or methanol as solvent. In some embodiments, the nanoparticle precursor comprises nickel or iron acetylacetonate. In some embodiments, the precursor comprises metal acetate with an alcohol such as ethanol as a solvent. In some embodiments, the precursor is nickel or iron acetate.

For embodiments in which an organometallic metal oxide precursor, a mixture of such precursors or a mixture of such precursors and one or more metal and/or metal oxide nanoparticles, is used on a carbon or its precursor, the organometallic precursors may be converted to metal and/or metal oxide nanoparticles of suitable particle size during carbonization or activation (e.g., through the use of controlled temperature/oxidation treatments).

For embodiments in which an organometallic precursor, or a mixture of such precursors is applied to a carbon material, the organometallic precursors may be converted to nanoparticles of suitable particle size and coverage during the temperature rise at the initial part of the activation process and prior to introduction of the etching agents such as air, steam, or carbon dioxide, for example by way of non-limiting illustration the methods described in Chem. Eur. J. 2006, 12:7282-7302 and in J. Am. Ceram. Soc. 2006, 89(6):1801-1808.

In some embodiments, the metal or metal oxide nanoparticles are prepared or obtained separately, for example by way of non-limiting illustration the methods described in Adv. Mater. 2005, 17(4):429-434. By way of example, reasonably uniform monodispersions of nickel nanoparticles of 2, 5, or 7 nm size can be prepared and easily redispersed into a coating solution using nonpolar organic solvents such as hexane or toluene. That solution can be used to subsequently coat the nanoparticles onto the carbon material or its precursor, for example prior to carbonization or prior to activation.

Placing a controlled density of metal or metal oxide nanoparticles of controlled size distribution (or, in preferable embodiments, their organometallic precursors) onto carbonaceous material of a suitable geometry and/or particle size that is then catalytically activated in a controlled fashion depending on the catalyst, nanoparticle size, and the activation conditions provides high proximate exterior surface mesoporous material well suited for electrochemical applications such as in double layer capacitors. By way of comparison, a mesoporous coconut shell carbon proposed as an electrocarbon had 345 square meters of mesopore surface out of a total 1850 square meter BET surface (19%), but specific capacitance of only 135 F/g similar to other very good conventional commercial electrocarbons. Activation with external nanoparticles has demonstrated mesoporosity as high as 735 square meters from a total surface of only 967 square meters (76%) after only 3 to 25 minutes at 900° C. using 30% steam, with mesopores imaged at between 5 and 10 nm. That is more than twice as much mesoporosity from only half the total surface, and the majority of this mesoporosity is accessible since neither sieved nor locally depleted under charge.

Unlike conventional activation, and unlike catalytic activation using catalytic precursors dissolved into or blended into a carbon precursor material such as pitch, the majority of mesopores according to this invention are created by the externally situated nanoparticles, and therefore are substantially continuous mesopores at least as large as the nanoparticle catalyst originating from the surface of the material. These effectively increase proximate exterior, are not sieved, and do not have apertures.

While it is possible to directly coat suspensions of metal or metal oxide nanoparticles of suitable size obtained separately, or to deposit them by means such as electroplating, these nanoparticles are preferably created during the carbonization/activation phases from coated precursor sols, such as the metal acetylacetonate and metal acetate complexes known in the art.

Organometallic complexes such as nickel or iron acetylacetonate (or equivalents thereof) in an appropriate solvent such as THF or toluene or benzyl alcohol can be coated onto carbon materials in any desired dilution, then the solvent removed (and optionally recovered) for example, by ordinary or flash evaporation, and the organometallic residue coating converted to metallic/oxide nanoparticles of a reasonably controlled nanoparticle size distribution covering the carbon's surfaces to any desired degree using controlled thermal decomposition processes known in the art.

In some embodiments, nickel and/or nickel oxide is a desirable metal/oxide. Nickel has a proven ability to form nanoparticles from about 2 nm to several nm in size from various precursor organometallic sols, as known in the art. Moreover, nickel oxide is known to exhibit pseudocapacitance thereby enhancing total capacitance in KOH electrolyte, and to be compatible both with carbon substrates and with the general chemistry of aqueous and organic electrolytes used in ultracapacitors. See, for example, Tai's Masters Thesis, etd-0725105-163206, (2002) in the Department of Chemical Engineering, National Cheng Kung University, Taiwan, and U.S. Pat. No. 5,963,417, and J. Electrochem. Soc. 2002, 149(7): A855-A861.

Notwithstanding the advantages of nickel, other metals such as cobalt or iron may also be especially useful for methods in accordance with the present invention depending on activation process and electrolyte. Cobalt may also contribute pseudocapacitance, is more reactive as a catalyst than nickel, and is compatible with lithium ion battery chemistries for hybrid devices such as Fuji Heavy Industries ‘LiC’. Iron is more catalytically reactive to carbon with steam activation than cobalt, so will produce more proximate exterior at lower temperatures with less activation time.

Mixtures of various metals/metal oxides may also be used. Ultimate pore density (and total surface porosity) and average mesopore size resulting from the catalytic nanoparticles is a function of metal or metal oxide type (catalytic potency), nanoparticle size, particle loading, and carbon activation conditions such as temperature, etchant concentration as a percentage of the neutral (e.g. nitrogen) atmosphere, and duration.

Depending on the electrolyte system, the operating voltage range of the device, and optimization for power or energy density, it may prove desirable to remove the catalytic metal nanoparticles from the carbon rather than remaining therein. They can optionally be removed by means such as simple acid washes, for example in hydrochloric or sulfuric acid, as known in the art.

This general process can provide a material according to the present invention compatible with conventional particulate carbon electrode manufacturing processes such as described in U.S. Pat. Nos. 6,627,252 and 6,631,074, the entire contents of both of which are incorporated herein by reference, except that in the event of any inconsistent disclosure or definition from the present application, the disclosure or definition herein shall be deemed to prevail. Optionally the material may be milled or otherwise processed to a particle size distribution best suited to the needs of a particular electrode manufacturing process or device, preferably prior to activation.

An electrode embodying features of the present invention, suitable for use in a capacitor or other electrochemical devices, includes a current collector foil, covered with a substantially mesoporous catalytic nanoparticle activated carbon material. EDLC electrodes are typically made of activated carbon bonded directly or indirectly onto a metal foil current collector, although metal oxides and conductive carbons can be used or admixed (see, for example, U.S. Pat. No. 6,491,789). In accordance with the present invention, activated carbon materials prepared by the methods described herein may be applied to current collectors together with additional metal oxides, conductive carbons, graphites, or the like for enhanced hybrid characteristics including enhanced pseudocapacitance.

A capacitor embodying features of the present invention includes at least one electrode of a type described herein. In some embodiments, the capacitor further comprises an electrolyte, which in some embodiments is aqueous, in other embodiments is organic. In some embodiments, the capacitor exhibits electric double layer capacitance. In some embodiments, particularly when residual catalytic metal oxide is present on or in connection with the surface of the activated carbon fibrous material, the capacitor further exhibits additional pseudocapacitance in some electrolyte systems.

Conventional carbon EDLCs with organic electrolytes use either propylene carbonate or acetonitrile organic solvents and standard ammonium fluoroborate salts such as tetraethylammonium (TEA) or triethyl methylammonium (TEMA). Some carbon and most commercial metal oxide EDLCs use aqueous electrolytes based on sulfuric acid (H₂SO₄) or potassium hydroxide (KOH). Any of these electrolytes or the like may be used in accordance with the present invention.

Since organic electrolytes have lower conductivity than aqueous electrolytes, they have slower RC characteristics and higher ESR contributions. However, since they have breakdown voltages above 3 V compared to about 1.2 V with aqueous electrolytes, organics produce higher total energy density since total energy is a function of voltage squared. Pores optimized for organics would optionally work for aqueous electrolytes also, since aqueous solvation spheres are smaller. Alternatively, smaller catalytic nanoparticles in accordance with this invention can be used to produce mesoporous carbon materials optimized for aqueous electrolytes. It is known . that mesoporosity is desirable even for the smaller solvated ions of aqueous systems. See Electrochem. Solid State Letter 2002, 5(12) A283-A285.

Activated mesoporous carbon materials, or their respective particles or fragments, embodying features of the present invention may be incorporated into all manner of devices that incorporate conventional activated carbon materials or that could advantageously be modified to incorporate activated mesoporous carbon materials. Representative devices include but are not limited to all manner of electrochemical devices (e.g., capacitors; batteries, including but not limited to one side of hybrid asymetric batteries such as the Fuji Heavy Industries Lithium Ion Capacitor (LIC); fuel cells, and the like). Such devices may be used without restriction in all manner of applications, including but not limited to those that potentially could benefit from high energy and high power density or the like. By way of illustration, devices containing activated carbons embodying features of the present invention may be included in all manner of vehicles (e.g., as elements in capacitors and/or batteries, or electrical combinations thereof, which may optionally be coupled to one or more additional components including but not limited to capacitors, batteries, fuel cells or the like); electronic devices (e.g., computers, mobile phones, personal digital assistants, electronic games, and the like); any device for which a combination of battery and capacitor features is desirable (combining the energy density of batteries with the power densities of capacitors) including an uninterrupted power supply (UPS) in order to accommodate power surges and power failure ride-throughs, cordless drills, and the like; any device that may advantageously contain a conventional batcap (i.e., a system of devices that provide a capacitor for handling power density and a battery for providing energy density, wired in parallel); electric utility grid devices such as statcoms and voltage dip compensators; and the like. In some embodiments, a device embodying features of the present invention comprises a capacitor used in a vehicle, including but not limited to an electric vehicle and hybrids thereof, or in conventional internal combustion engine vehicles in place of or as a supplement to the engine starter battery. Representative vehicles for use in accordance with the present invention include but are not limited to automobiles, motorcycles, scooters, boats, airplanes, helicopters, blimps, space shuttles, human transporters such as that sold under the trade name SEGWAY by Segway LLC (Manchester, N.H.), and the like.

The individual processing acts used in the methods embodying features of the present invention—organometallic solvent coating, metallic and/or metal oxide nanoparticle creation, carbonization, activation, and carbon particle milling—are well understood in the art and have been thoroughly described in the references cited herein. Each of the patents, patent publications, and non-patent literature references cited is incorporated herein by reference in its entirety, except that in the event of any inconsistent disclosure or definition from the present application, the disclosure or definition herein shall be deemed to prevail.

The techniques of carbonization and activation described above may be implemented using any of the well-known techniques described in the literature. By way of example, various processes that may be used in accordance with the present invention include but are not limited to those described in U.S. Pat. No. 6,737,445 to Bell et al.; U.S. Pat. No. 5,990,041 to Chung et al.; U.S. Pat. No. 6,024,899 to Peng et al.; U.S. Pat. No. 6,248,691 to Gadkaree et al.; U.S. Pat. No. 6,228,803 to Gadkaree et al.; U.S. Pat. No. 6,205,016 to Niu; U.S. Pat. No. 6,491,789 to Niu; U.S. Pat. No. 5,488,023 to Gadkaree et al.; as well as in U.S. Patent Publication Nos. 2004/0047798 A1 to Oh et al., 2004/0091415 A1 to Yu et al., and 2004/0024074 A1 to Tennison et al. Additional description is provided in Chemical Communications, 1999, 2177-2178; and Journal of Power Sources, 2004, 134, No. 2, 324-330.

By way of illustration of the utility of the invention described herein, it is known that the total capacitance of an ELDC is a direct linear function of accessible surface area, defined as the total area of surface features greater than at least one, and for full coverage at least twice the sphere of salvation, or approximately 2-3 nm, of the solvated ions in electrolytes. The governing equation is:

C/A=e/(4*π*d) (eq 1)

where C is capacitance, A is usable surface area, e is the relative dielectric constant of the electrolyte, and d is the distance from the surface to the center of the ion (Helmholtz) layer in the electrolyte. For any given electrolyte solvent and salt, e and d are fixed, so the right side of the equation is some constant k. Substituting and rearranging,

C=kA (eq 2)

Thus, doubling usable surface area effectively doubles capacitance.

Korean experimenters achieved the equivalent of 632 F/g specific capacitance with steam activated Espun PAN fibers averaging 200-400 nm diameter and KOH electrolyte. They achieved a BET surface of only 830 square meters, but nearly all proximate exterior. The fibers had 62% mesopores averaging 3.2 nm (and with very high probability of access given the comparatively small fiber diameter and limited interior compared to exterior, and smaller ion sizes of the KOH aqueous electrolyte used). Applied Physics Letters (2003) 83(6) 1216-1218. The 76 μF/cm² that was measured is about the theoretical maximum possible with two spheres of solvation for the kinetically controlling ion in the potassium hydroxide electrolyte. Given the well known maximum plane packing limit of circles or spheres from the mathematics of topology (for the Helmholtz layer) equal to (1/6)π√3 or 0.9068996821 and the solvated potassium ion dimension of about 10 angstroms, the alternative international definition of the coulomb as 6.241250969 . . . E+18 elementary charges computes a capacitance (ignoring any contribution of the exponential decline in the diffuse region of the Debye distance beyond the outer Stern or Helmholtz plane) of 74 μF/cm² at one volt. Therefore approaching the theoretical maximum is possible with a surface that is mostly external (due in this example to very fine diameter), and with internal pores with high probability of access to external electrolyte without ionic sieving or local depletion under charge.

The equivalent theoretical maximum computation for the most common electrolyte salt, TEA, in acetonitrile solvent is 24.4 μF/cm². The equivalent theoretical maximum in propylene carbonate is around 19 μF/cm², about the reported specific capacitance on the dropped mercury electrode for propylene carbonate electrolytes (see U.S. Pat. No. 5,877,935).

A 1000 square meter proximate exterior produced by mesoparticle catalytic activation will therefore surprisingly have double layer capacitance of about 245-F/g in TEA/AN, and 190 F/g in TEA/PC, substantially above all reliably reported carbons. Specific capacitance substantially higher than anything that has been commercially available surprisingly results from the simple and inexpensive process described herein.

By way of further illustration of the invention's utility, a robust electrode materials mathematical model developed to compute the impact of multiple independent process variables readily computes EDLC capacitance for any particulate or fiber fragment electrocarbon from first principles, for any electrolyte system. Maximum theoretical electrolyte capacitance per usable square cm of proximate carbon surface is computable from the packing of solvated ions and the alternative definition of the Coulomb as above. Exterior activated carbon surface rugosity can be estimated from published data, or measured (for example, by AFM as in Carbon 1999, 37:1809-1816). Particulate macro-rugosity (sphericity) can be estimated from standard reference materials (such as Micromeritics calibration powders); this is not a factor for fibrous material. Pore size distributions enable computation of the probability of internal mesopore access by the various mathematical methods described above, and thereby the proportion of internal mesopores (mostly proximate to the exterior surface) that are likely accessible. Known random packing mathematics computes the density of the final electrode material (and thereby the number of particles and their surface per weight or volume of electrode) for either particulate or fibrous particle morphologies and any particle size distribution. The additional usable rugosity contributed directly by the catalytic nanoparticles per carbon particle is computable using analytic geometry for any nanoparticle size, coverage, and average activation pore depth (modeled as catalytically drilled cylindrical ‘wormholes’). The following examples give some computed results with comparisons to measured equivalent material.

### EXAMPLE 1

Particulate carbon averaging 8 micron diameter, no catalytic nanoparticle derived mesoporosity. Computed specific capacitance value from first principles and an average chemically activated (KOH) mesopitch pore size distribution: 130 F/g. Actual value reported by MeadWestvaco for an alkali activated resin: 133 F/g.

### EXAMPLE 2

Particulate carbon averaging 9 micron, no catalytic nanoparticle derived mesoporosity. Computed value from first principals and an average physically activated pore size distribution for pitch: 91.8 F/g. Actual value reported for commercial thermally activated MeadWestvaco resin: 97 F/g. Actual value for Kuraray BP20: 100 F/g.

### EXAMPLE 3

Fibrous carbon derived from KYNOL 2600 at 8.5 micron diameter, no catalytic nanoparticle derived mesoporosity. Computed value from first principals and published pore size distribution (30%>1.7 nm, 1 cc/g total pore volume): 76.8 F/g. Measured experimental 87.8 F/g; the experimental electrode material was denser than the random packed model since a woven carbon cloth, so the computation underestimates. See Carbon 2005, 43:1303-1310.

### EXAMPLE 4

Particulate carbide derived carbon averaging 2 micron particle diameter, with all pores below 1 nm and exterior rugosity 40% of conventional activated carbon. Computed value from first principles: 123 F/g (all external surface). Reported capacitance of carbide derived carbons with chlorination temperatures from 500 C to 800 C with average particles of 2 nm: 125 F/g to 138 F/g. See ScienceExpress 17 Aug. 2006, page 1.

### EXAMPLE 5

Particulate carbon averaging 10 micron diameter with 40% catalytic nanoparticle coverage, average nanoparticle 6 nm, average wormhole length (depth) 15× particle width: 206 F/g.

### EXAMPLE 6

Particulate carbon averaging 10 micron with 30% catalytic nanoparticle coverage, average nanoparticle 8 nm, average wormhole depth 20× particle width: 200 F/g.

By way of further illustration of the utility of this invention, a series of experiments were conducted using two carbon materials, unactivated but fully carbonized KYNOL fiber averaging about 13 micron in diameter and an anthracite coal ‘Minus 100’ particulate powder averaging about 4.7 micron diameter with high purity and good conductivity. Nanoparticles from iron and nickel were used. Nanoparticles were formed by two means, solvent deposition of metal acetylacetonate dissolved in tetrahydrofuran and by an electrodeposition process.

Carbonized KYNOL (phenolic novaloid resin) is not deeply activated by steam at 900° C. for one hour. According to the manufacturer, activation is ordinarily accomplished simultaneously with carbonization at 800° C. in steam. After carbonization alone, the material is relatively impervious to physical activation gasses (one of its useful commercial properties). Manufacturer supplied carbonized material increased its BET measured surface from 0.096 square meters/gram to 112-113 m²/g, and the exterior surface was shown to be self replicating (roughly constant as mass loss increased over time), with conventional steam activation at 900° C. for durations from 15 minutes to 1 hour.

Solvent coated carbonized KYNOL with 0.1% metal/carbon by weight acetylacetonate nanoparticle precursor dissolved in tetrahydrofuran followed by room temperature solvent evaporation resulted in nickel/oxide or iron/oxide nanoparticles imaged at 40-60 nm diameter in several experiments. These relatively large nanoparticles are attributable the slow evaporation of solvent and to the paucity of nucleation sites on carbonized KYNOL surface since its micropores are annealed. These nanoparticles are larger than optimal for capacitance, but were sufficiently large to be imaged by available SEM instruments, so served as a useful experimental vehicle.

In one experiment, the catalytically activated surface increased to 309.4 m²/g with steam for 1 hour at 900° C. using 0.1% nickel acetylacetonate nanoparticle precursor spray coated onto the KYNOL, compared to 112 m²/g without the organometallic coating. The total pore volume estimated by DFT was only 0.17 cc/g. This carbon had a specific capacitance of 26.2 F/g measured in a three-electrode reference system using 1.8 molar TEMA/PC with an intrinsic capacitance computed by the methods herein of 21.4 μF/cm². Thus about 122 square meters of the total surface, or 40%, was utilized. That is very high for an aprotic electrolyte even with low total surface carbons. By way of comparison, standard Vulcan XC-72 carbon black having BET 240 m²/g measured 12.6 F/g in TEA/AN or 22% surface utilization computed by the methods herein. See Carbon 2005, 43: 1303-1310. By way of further comparison, commercial Marketech carbon aerogel having a Bet surface of 400 m²/g measured 28 F/g using a 2 molar concentration of LiBF₄ in AN, also a 22% surface utilization computed by the methods herein. See Smith, Proceedings of the 16^{th} International Seminar on DLC pages 277-284. Thus the processes of this invention, even with low surface areas under mild activation of difficult KYNOL carbon, produce material that is up to 70% proportionately better normalized capacitance (μF/cm²) than equivalent surface conventional carbons, with almost twice the electrochemical surface utilization.

A second experiment used 0.1% by weight nickel acetylacetonate, solvent immersion coated on carbonized KYNOL followed by solvent evaporation at room temperature. The material then underwent a two part process. Step one calcined the organometallic coated carbon in air for 60 minutes at 350° C., followed by conventional activation in steam for 1 hour at 900° C. (SEM imaging of cross sections of similarly made materials show nanoparticle penetration up to 1.5 to 2 microns (up to 2000 nm) depending on temperature and duration. Larger than optimal nanoparticle catalyzed “wormholes” resulted from the 40-60 nm imagable nanoparticles, and these features ranged from smaller than the limit of resolution of the SEM instrument to as large as 150 nm diameter (with proportions depending on nickel or iron.) The BET surface of this carbon as made into experimental electrodes was only 83.3 square meters, with a total pore volume of only 0.04887 cc/g, of which 57.7% was meso/macropore as calculated by DFT. All measurements were taken using a Micromeritics ASAP 2010 instrument. The specific capacitance of the functional two electrode capacitor cell, as determined by cyclic voltammetry at a sweep rate of 20 mV/s to 2 volts, was 20.0 F/g at 1 volt. Therefore virtually the entire measured BET electrode surface made from this carbon was able to contribute capacitance, since the cell measured about 24 uF/cm². The surprising result according to this invention is that activated carbons can be engineered to have the substantial majority of their surface contribute capacitance, compared to 10% (U.S. Pat. No. 6,491,789) to 20% (U.S. Pat. No. 6,737,445) conventionally.

By way of illustrating the commercial economic importance of materials according to this invention, a third experiment used 0.1% iron acetylacetonate spray coated onto particulate anthracite ‘Minus 100’ followed by only 20 minutes of steam activation at 900° C. SEMs after the activation step show no nanoparticles visible at the limit of resolution of the instrument. The BET surface measured after the steam activation was 842.8 m²/g. Total pore volume measured by DFT was 0.460 cc/g, comprising 77.4% micropores and 22.6% meso/macropores calculated by DFT. All measurements were taken using a Micromeritics ASAP 2010. This is a lower mesopore ratio than desirable for optimal electrocarbons, attributable to the low 0.1% metal/carbon loading and very small nanoparticles from abundant nucleation sites. It is, however, a typical mesopore proportion for conventional activated electrocarbons, which may range from a low of 5% to a high of 22% mesopore. See Walmet (MeadWestvaco), Proceedings of the 16^{th} International Seminar on DLC page 139. By comparison, the ‘Minus 100’ anthracite conventionally activated for one hour in steam at 900° C. had only 801 square meters BET surface, and 0.406 cc/g of total pore volume. Even this small amount of external very fine diameter nanoparticle catalyst resulted in more total surface and more pore volume, in less than half the activation time.

A two electrode cell made from this nanoparticulate activated ‘Minus-100’ carbon, measured by cyclic voltammetry at a sweep rate of 20 mV/s measured 65.65 F/g at one volt (using a maximum of 2 volts) using 1.8 m TEMA/PC electrolyte. A surprising 307 m² or 36% of this carbon's BET electrode surface was utilized as computed by the methods herein, despite suboptimally having 77% micropores that conventionally contribute little capacitance in this electrolyte. Thus the methods of this invention result in utilizable electrochemical surface proportions at least 75% better (36% versus 10%-20%) than conventional electrocarbons, at half or less of conventional activation time and cost. By way of comparison, physical activation conventionally takes up to 2 hours (U.S. Pat. No. 5,990,041, U.S. Application 2004/0097369) while chemical activation may take up to 20 hours (U.S. Pat. No. 5,877,935) and is conventionally at least two hours.

A fourth experiment shows the combined utility of enhanced electrochemical surfaces produced with a faster, lower cost process. Particulate anthracite ‘Minus 100’ was spray coated with 1.5% iron acetylacetonate dissolved in THF, then activated at 900° C. with 1:1 air:nitrogen for 10 minutes followed by steam activation for 20 minutes at 900° C. The BET surface of the material was 760.3 m²/g and the total pore volume 0.30429 cc/g, both measured using a Micromeritics ASAP 2010. Differences from the 0.1% nickel material in experiment three are attributable to differently processing the more catalytically active iron, and the increased organometallic loading for larger nanoparticles, still below the resolution limits of available SEM instruments. Specific capacitance in the 1.8 m TEMA/PC electrolyte was 100.0 F/g at 1 volt and about 108 F/g at 2 volts, with an ideally shaped CV indicating pure double layer capacitance, measured using a 20 mV/s sweep rate at up to 2.0 volts. That is comparable to commercial electrocarbons having 100% to 150% more BET surface and activated for at least twice as long. At 13.16 μF/cm², this carbon is about twice the normalized value of commercial MeadWestvaco electrocarbons (reported at 5.14 μF/cm² to 7.11 μF/cm² by Walmet in the Proceedings of the 16^{th} International Seminar on DLC at 139-140.)

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method of preparing a mesoporous carbon particle comprising the steps of:
providing at least one particle which is either carbon or a carbon precursor;
coating the carbon particle or its precursor with metal and/or metal oxide nanoparticles or their precursors;
if the coating is a nanoparticle precursor, thermally decomposing the precursor to form nanoparticles;
if the particle is a carbon precursor, carbonizing the particle;
catalytically activating the carbon with at least one activation process to form a mesoporous carbon particle with external mesopores that range in size from about 2 nm to about 50 nm.

2. The method of claim 1, wherein the nanoparticles are metal oxides.

3. The method of claim 2, wherein the metal oxide is an oxide of nickel, iron, cobalt, or titanium or a combination thereof.

4. The method of claim 1, wherein the catalytically activating step comprises treating the heated carbon particle with steam, carbon monoxide, carbon dioxide, or a combination thereof.

5. The method of any of the preceding claims, wherein the majority of mesopores range in size from about 2 to about 50 nm.

6. The method of any of the preceding claims, wherein activating forms the mesoporous carbon particle with a porosity volume comprised of greater than about 50% mesopores.

7. The method of claim any of the preceding claims, wherein activating forms the mesoporous carbon particles with a porosity volume comprised of greater than about 35% mesopores.

8. The method of claim any of the preceding claims, wherein the metal/metal oxide nanoparticle or their precursors are suspended in solvent, and wherein the method further comprises the step of evaporating the solvent prior to the catalytically activating step.

9. The method of claim any of the preceding claims, wherein a plurality of carbon particles is provided.

10. The method of claim any of the preceding claims, further comprising milling the mesoporous carbon particles.

11. The method of claim any of the preceding claims, further comprising the step of forming a layer by depositing a slurry or solution of a plurality of mesoporous carbon particles and a binder on a surface and removing the liquid carrier.

12. The method of claim 11, further comprising a step of compacting the layer.

13. A method of preparing a mesoporous carbon particle comprising the steps of:
providing at least one particle which is either carbon or a carbon precursor;
coating the carbon particle with precursor to a organometallic nanoparticle; and
if the particle is a carbon precursor, then carbonizing the particle to form a carbon particle coated with organometallic nanoparticles and then catalytically activating the carbon to form a mesoporous carbon particle with mesopores that range in size from about 2 nm to about 50 nm; or
if the particle is a carbon particle, then activating the particle to concomitantly form an organometallic nanoparticle which in turn forms a mesoporous carbon particle with mesopores that range in size from about 2 nm to about 50 nm.

14. The method of claim 13, wherein the organometallic precursor is metal acetylacetonates or metal acetates.

15. The method of claim 13 or 14, wherein in the coating step, the precursor is suspended in solvent.

16. A carbon material consisting essentially of a first population of substantially similarly sized mesoporous carbon particles with mesopores that range in size from about 2 nm to about 50 nm.

17. The material of claim 16, wherein the material further comprises a binder.

18. An electrode comprising:
a current collector; and
the material of claim 16 or 17 in electrical contact with the current collector.

19. Use of the material of claim 16 in an electrochemical device, hydrogen storage device, filtration device, or catalytic substrate.

20. Use of the material of claim 16 in a capacitor, battery, or fuel cell.
